(19) United States
(12) Patent Application Publication
(10) Pub. No.: US 2026/0091849 A1
(43) Pub. Date: Apr. 2, 2026

(54) COVER FOR PONTOON BOAT

(71) Applicant: Commercial Sewing, Inc., Torrington, CT (US)

(72) Inventor: David Mazzarelli, Torrington, CT (US)

(21) Appl. No.: 19/346,959

(22) Filed: Oct. 1, 2025

Related U.S. Application Data
(60) Provisional application No. 63/701,787, filed on Oct. 1, 2024.

(51) Int. Cl. B63B 17/02; H01F 7/02

(52) U.S. Cl. CPC B63B 17/02; H01F 7/0263

(57) ABSTRACT

A cover for a watercraft includes a cover body connectable to the watercraft, and a fastening system coupled to the cover body. The fastening system being operable to selectively apply tension to the cover body. At least one attachment feature is arranged at an underside of the cover body. The at least one attachment feature is engageable with a receiving feature of the watercraft to restrict movement of the cover relative to the watercraft when the cover is not tensioned.

### CROSS-REFERENCE TO RELATED APPLICATIONS

This application claims the benefit of U.S. Provisional Application No. 63/701,787 filed Oct. 1, 2024, the disclosure of which is incorporated herein by reference in its entirety.

### BACKGROUND

Exemplary embodiments of the present disclosure relate to a cover for a boat, and more particularly, to a cover for use with a pontoon boat.

It is well known to provide a boat with a cover to protect the inside of the boat when the boat is not in use. In many instances, boats utilize covers designed to be affixed to the boat via a plurality of snaps or other affixing mechanisms. The snap members are spaced about the entire perimeter of the cover to effect affixation thereof. For example, pontoon boats typically include a plurality of snap members affixed to the outboard side of the rails forming the perimeter fencing of the pontoon boat. Covers of this type are relatively difficult to install about the boat.

### BRIEF SUMMARY

According to an embodiment, a cover for a watercraft includes a cover body connectable to the watercraft, and a fastening system coupled to the cover body. The fastening system being operable to selectively apply tension to the cover body. At least one attachment feature is arranged at an underside of the cover body. The at least one attachment feature is engageable with a receiving feature of the watercraft to restrict movement of the cover relative to the watercraft when the cover is not tensioned.

In addition to one or more of the features described above, or as an alternative, in further embodiments the at least one attachment feature includes a magnet.

In addition to one or more of the features described above, or as an alternative, in further embodiments the receiving feature is a magnetic material.

In addition to one or more of the features described above, or as an alternative, in further embodiments the receiving feature is a steel plate.

In addition to one or more of the features described above, or as an alternative, in further embodiments the receiving feature includes a magnet.

In addition to one or more of the features described above, or as an alternative, in further embodiments the at least one attachment feature includes a contoured channel.

In addition to one or more of the features described above, or as an alternative, in further embodiments the contoured channel is J-shaped.

In addition to one or more of the features described above, or as an alternative, in further embodiments the at least one attachment feature includes a tension member formed into a continuous loop.

In addition to one or more of the features described above, or as an alternative, in further embodiments the receiving feature is a fixture of the watercraft.

In addition to one or more of the features described above, or as an alternative, in further embodiments the at least one attachment feature includes a tension member having a first end attached to the cover and a distal end and an engagement feature coupled to the distal end of the tension member. The engagement feature is engageable with the receiving feature of the watercraft to restrict movement of the cover relative to the watercraft when the cover is not tensioned.

In addition to one or more of the features described above, or as an alternative, in further embodiments the watercraft includes a rub rail arranged at a periphery of the hull. The receiving feature is arranged at the rub rail.

In addition to one or more of the features described above, or as an alternative, in further embodiments the rub rail includes an inwardly extending flange and the receiving feature is arranged at an upper surface of the inwardly extending flange.

According to an embodiment, a cover for a watercraft includes a cover body connectable to the watercraft, and a fastening system coupled to the cover body. The fastening system being operable to selectively apply tension to the cover body. At least one attachment feature is arranged at the cover body and is connectable to a receiving feature at the watercraft. The at least one attachment feature is movable relative to the watercraft when coupled to the receiving feature.

In addition to one or more of the features described above, or as an alternative, in further embodiments the at least one attachment feature is automatically decoupled from the receiving feature when tension is applied to the cover body via the fastening system.

In addition to one or more of the features described above, or as an alternative, in further embodiments the at least one attachment feature includes a magnet.

In addition to one or more of the features described above, or as an alternative, in further embodiments the receiving feature is a magnetic material.

In addition to one or more of the features described above, or as an alternative, in further embodiments the cover body comprises a pocket wrapped over a corner of the deck.

In addition to one or more of the features described above, or as an alternative, in further embodiments the at least one attachment feature includes a contoured clip engageable with a flange of the watercraft.

In addition to one or more of the features described above, or as an alternative, in further embodiments the contoured clip is a J-shaped clip having a clearance, and the receiving feature of the watercraft is positionable within the clearance.

According to an embodiment, a cover for a watercraft includes a cover body connectable to the watercraft and a fastening system coupled to the cover body. The fastening system is operable to selectively apply tension to the cover body. At least one attachment feature is arranged at an underside of the cover body and is engageable with the watercraft. The at least one attachment feature includes a tension member attached to the cover and an engagement feature coupled to the tension member. The engagement feature is engageable with the watercraft to restrict movement of the cover relative to the watercraft when the cover is not tensioned.

### BRIEF DESCRIPTION OF THE DRAWINGS

The following descriptions should not be considered limiting in any way. With reference to the accompanying drawings, like elements are numbered alike:

FIG. 1A is side perspective view of an example of a pontoon boat according to an embodiment;

FIG. 1B is a top view of a portion of the pontoon boat of FIG. 1A according to an embodiment;

FIG. 2 is a side view of an example of another boat according to an embodiment;

FIG. 3A is a perspective view of a pontoon boat including a cover according to an embodiment;

FIG. 3B is a front end perspective view of a pontoon boat and cover according to an embodiment;

FIG. 4 is a front end perspective view of a pontoon boat having an attachment feature and a cover including a receiving feature according to an embodiment;

FIG. 5 is a perspective view of an attachment feature of a cover according to an embodiment;

FIG. 6A is a perspective view of an attachment feature of a cover according to an embodiment;

FIG. 6B is another perspective view of an attachment feature of a cover according to an embodiment;

FIG. 7 is a perspective view of an attachment feature of a cover according to another embodiment;

FIG. 8A is a perspective view of the attachment feature of FIG. 7 during installation of a cover according to an embodiment;

FIG. 8B is a perspective view of the attachment feature of a FIG. 8A installed according to an embodiment;

FIG. 9 is a perspective view of an attachment feature of a cover according to another embodiment;

FIG. 10 is a perspective view of an attachment feature of a cover according to another embodiment; and

FIG. 11 is a perspective view of an attachment feature of a cover according to another embodiment.

### DETAILED DESCRIPTION

A detailed description of one or more embodiments of the disclosed apparatus and method are presented herein by way of exemplification and not limitation with reference to the Figures.

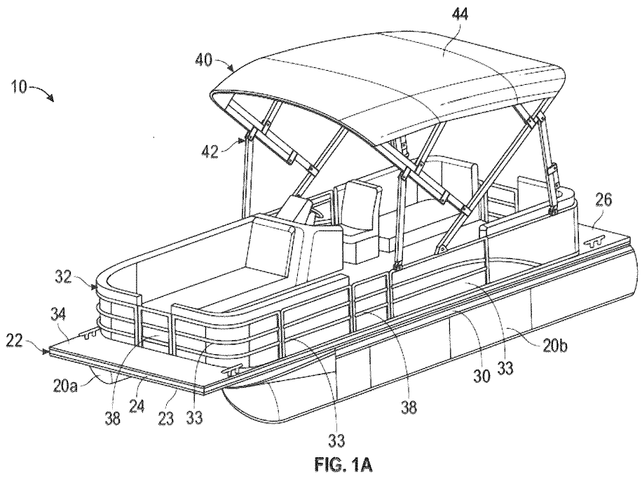

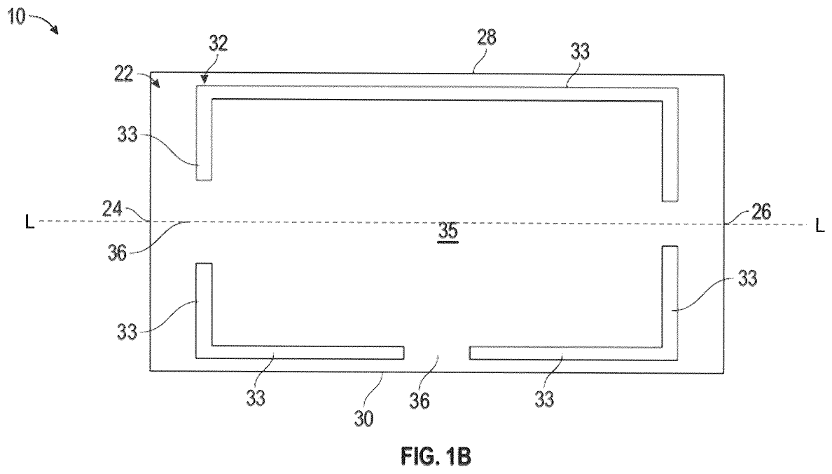

With reference now to FIGS. 1A and 1B, an example of a vehicle or watercraft, such as a boat is illustrated. The illustrated watercraft or boat 10 is a pontoon boat including one or more elongated pontoons. In the illustrated, non-limiting embodiment, the boat 10 includes a pair of pontoons 20a, 20b (FIG. 1A) arranged substantially parallel to one another. Although a boat 10 having two pontoons 20a, 20b is illustrated and described herein, it should be understood that a boat 10 having any number of pontoons, such as three pontoons, or four pontoons for example, is also within the scope of the disclosure. The pontoons are secured to a bottom surface 23 of a deck 22. The pontoons 20a, 20b in combination with the deck 22 may form the hull of the boat 10. The deck 22 has a bow or forward portion 24, a stern or aft portion 26, and two opposite lateral sides 28, 30. The first pontoon 20a and the second pontoon may be positioned adjacent to the first lateral side 28 and the second lateral side 30, respectively. A longitudinal axis L (FIG. 1B) of the boat 10 extends through a center of the bow 24 and a center of the stern 26.

Although not shown, it should be appreciated that the boat 10 may include one or more propulsion systems for moving the boat through water. In some embodiments, the one or more propulsion systems may include at least one of an outboard motor, an inboard motor, a jet powered motor, or a combination thereof. In certain embodiments, the one or more propulsion systems may include propellers and/or impellers.

As shown, a railing system 32 including a plurality of fences or fence portions 33 may be mounted to and extend vertically upward from a top surface 34 of the deck 22. The railing system 32 extends about at least a portion of the deck 22, and in some embodiments, about an entire periphery of the deck 22. In an embodiment, the railing system 32 has one or more openings 36 (FIG. 1B) formed therein. Furthermore, the railing system 32 may include a door 38 (FIG. 1A) at one or more of the openings 36. Such a door 38 may be movable between a closed position, in which the opening 36 is sealed, and an open position, in which the opening 36 is exposed.

In the illustrated, non-limiting embodiment shown in FIG. 1A, the boat 10 additionally includes a movable structure 40, such as a bimini, canopy, or marine top for example, mounted to the railing system 32 and/or to the deck 22. As shown, the movable structure 40 includes a movable frame 42 comprised of a number of structural members that support a piece of material 44. The frame 42 is movable between an extended position in which the movable structure 40 provides shade or shelter from the elements over at least a portion of the deck 22, and a collapsed position, in which the movable structure 40 is stowed.

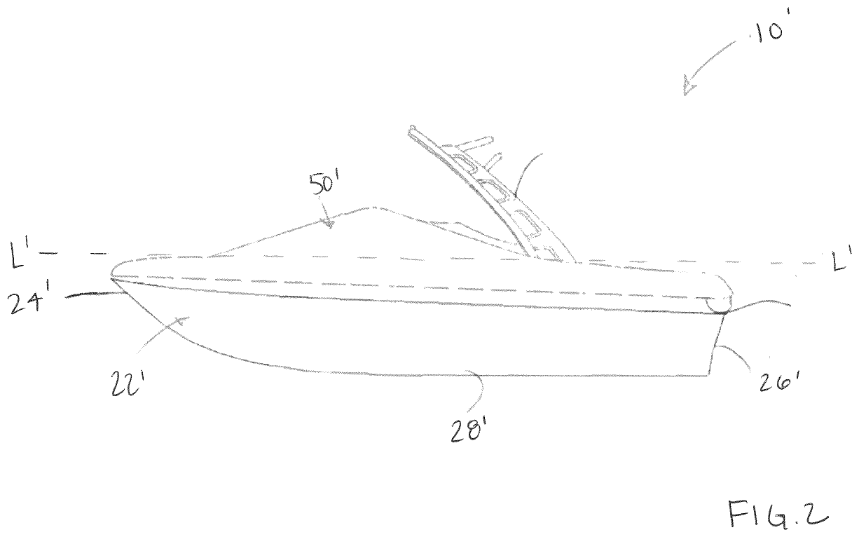

Another example of a watercraft or boat 10′ is illustrated in FIG. 2. As shown, the watercraft 10′ includes a hull or body 22′ having a bow or forward portion 24′, a stern or aft portion 26′, and two opposite lateral sides 28′ (only one shown). A longitudinal axis L′ of the boat 10′ extends through a center of the bow 24 and a center of the stern 26′. In an embodiment, the watercraft is a ski, sport, wakeboard, fishing, or other style of boat 10′ that includes a tower or arch type structure 32′ extending upwardly from a deck (not shown) of the boat 10′. However, it should be appreciated that embodiments that do not include a tower 32′ are also within the scope of the disclosure. Further, it should be understood that the boats 10, 10′ illustrated and described herein are intended as an example only and that a watercraft having any suitable configuration is also within the scope of the disclosure. For example, hybrid boats having a deck of a pontoon and a hull of a standard boat for example, are also within the scope of the disclosure.

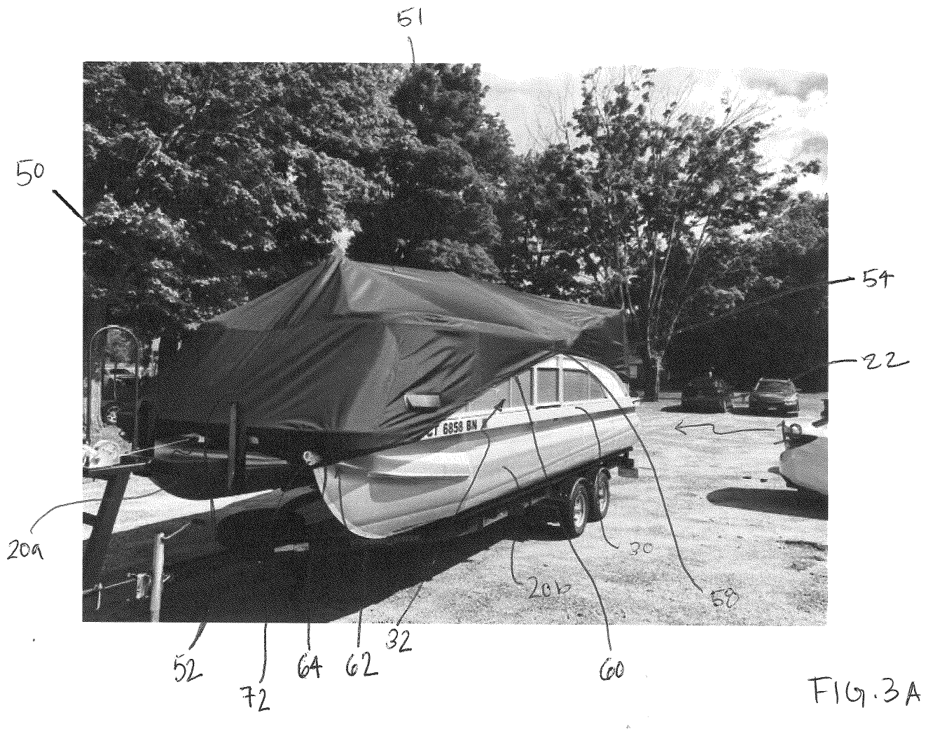

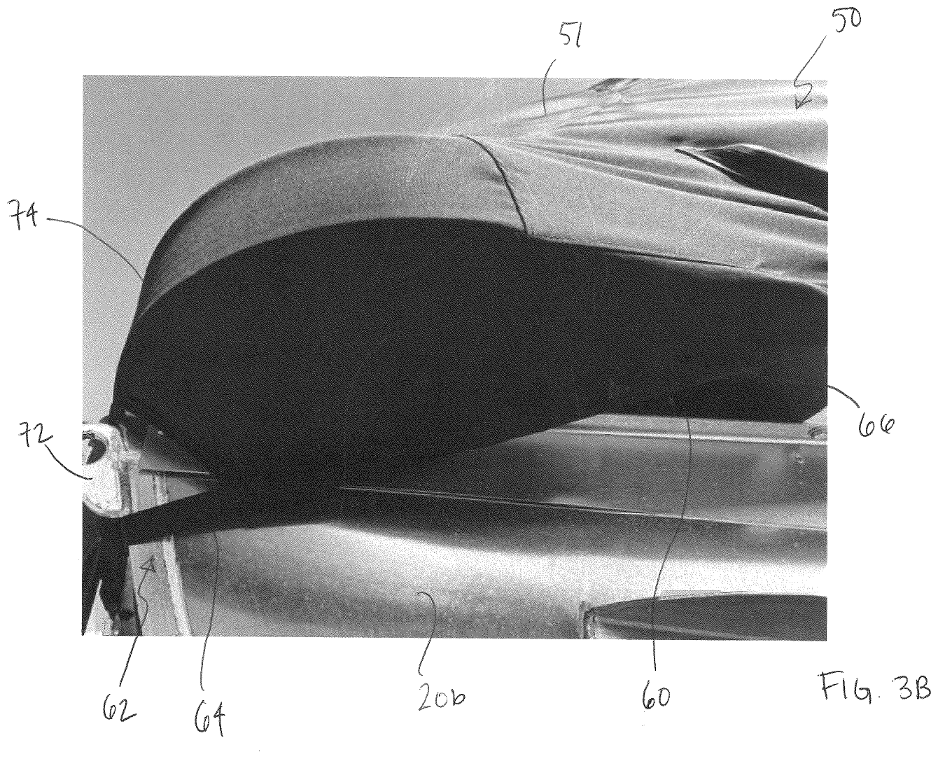

A cover is typically installed over a portion of a boat to prevent water and other debris from collecting inside the boat when the boat is not in use. For example, such a cover may be used when the boat 10, 10′ is moored. With further reference now to FIGS. 3-8, an example of a cover 50 for use with a boat, such as pontoon boat 10 for example, is illustrated according to an embodiment. Although the cover 50 is illustrated and described herein with respect to a pontoon boat, such as boat 10, it should be understood that such a cover 50 may be adapted for use with another type of boat or watercraft. For example, a cover 50′ having a substantially identical configuration may be adapted for use with the watercraft of FIG. 2, as shown.

The cover 50 includes a cover body 51 formed from a fabric, such as canvas or nylon for example, or another suitable weatherproof material. The cover body 51 may be dimensioned to conform closely to one or more exterior contours of the watercraft 20. In the illustrated, non-limiting embodiment, the cover body 51 is sized to protect the playpen 35, which is the area of the deck 22 positioned within the fences 33 of the railing system 32. For example, when installed about the boat 10, the cover body 51 extends between each of the sides of the railing system 32. Further, a bow end 52 of the cover body 51 may be configured to overlap with or extend beyond a portion of the railing system 32 located near the bow 24, an aft end 54 of the cover may be configured to overlap with or extend beyond a portion of the railing system 32 arranged near the stern 26, and the lateral sides 56, 58 of the cover body 51 may be configured to connect to or overlap with a portion of the railing system 32 positioned near the lateral sides 28, 30 of the deck 22. In an embodiment, a bottom 60 of the cover body 51 defines an opening such that the cover body 51 may be fitted to and secured about a portion of a periphery of the deck 22. For example, the bottom 60 of the cover body 51 may fit about the bow 24 and/or the stern 26 of the deck 22. In embodiments where a movable structure 40, such as a bimini frame or tower is affixed to the watercraft 10, the movable structure 40 may be stowed at a location underneath the cover body 51 or may be stowed at a position above the cover body 51.

The cover 50 additionally includes a fastening system 62 operable not only to attach the cover body 51 to the boat 10, but also to tighten the cover body 51 about a portion of the boat 10, thereby creating tension in the cover body 51. In the illustrated, non-limiting embodiment, the cover body 51 is configured to tighten about at least a portion of the railing system 32. For example, the aft end 54 of the cover body 51 may wrap around and tighten about a rear of the railing system 32 and/or the lateral sides 56, 58 of the cover body 51 may wrap around and tighten about the sides of the railing system 32.

The fastening system 62 includes at least one tension member 64 that extends about a hem formed at the bottom 60 of the cover body 51. The at least one tension member 64 includes one or more straps of webbing as shown, or may be formed from another suitable material, such as a rope or cable for example. In an embodiment, the hem of the cover body 51 includes one or more hem pockets 66 (see FIG. 5) formed at one or more sides of the body 51 of the cover 50 and the at least one tension member 64 is threaded through at least some or all of these hem pockets 66. The at least one tension member 64 may be a single and continuous tension member that extends about an entire periphery of the hem 60 of the cover body 51; however, embodiments where the tension member 64 is not continuous, such as where the tension member 64 includes a plurality of connected or separate tension members, or embodiments where the tension member 64 extends about only a portion of the hem 60 of the cover body 51 are also contemplated herein.

In the illustrated, non-limiting embodiment illustrated in FIG. 3, the bow end 52 of the cover body 51 is configured to overlap and extend downward beyond a rub rail 70 arranged at the foremost surface of the deck 22. As shown, the at least one tension member 64 of the fastening system 62 may be arranged generally beneath a bow eye 72 formed at or generally adjacent to each pontoon 20a, 20b. However, in other embodiments, the at least one tension member 64 may have one or more buckles or other connection mechanisms (not shown) associated therewith such that a free end of the tension member 64 may be threaded through one or more bow eyes 72 to couple the cover body 51 thereto.

The cover body 51 may include one or more pockets 74, such as formed at an interior surface of the cover 50. Each of the pockets 74 may be structured to wrap over and/or grab a corner of the deck 22. For example, the pockets 74 may wrap over the front corners of the deck 22 arranged at an interface between the bow 24 and the lateral sides 28, 30 of the deck, and when the at least one tension members 64 is tightened, a portion of each pocket 74 may contact a bottom surface 23 of the deck 22. The portion of the pocket 74 contacting the bottom surface 23 of the deck 22 may transmit an upward force on the bottom surface 23 of the deck 22, thereby limiting movement of the pocket 74 relative to the deck 22. In an embodiment, the tensioning force acting on the cover body 51 may retain the pocket 74 in a desired position adjacent to a front corner of the deck 22.

During installation of the cover 50 about a boat, such as a pontoon boat 10 for example, the cover 50 is first arranged about the boat 10 before the fastening system 62 is used to tension to the cover 50. However, in windy conditions, it can be difficult to retain the cover 50 at its desired position when the cover 50 is not tensioned. For example, wind may blow the cover 50 away from or off of the front corners (i.e., the interface between the bow and the lateral sides) of a pontoon boat 10 when the cover 50 is not tensioned.

To prevent this undesired movement of the cover body 51 during installation, the cover may include one or more attachment features 100. In an embodiment, the cover body 51 includes a first attachment feature positionable near the first lateral side 56 of the cover body 51 and a second attachment feature positionable near the second lateral side 58 of the cover body 51. The first and second attachment features 100 may be generally proximate the front or bow end 52 of the cover body 51; however, embodiments where one or more attachment features 100 are alternatively or additionally located at another position about the cover body 51 are also contemplated herein. For example, embodiments where one or more attachment features 100 are arranged generally centrally between the bow end 52 and aft end 54 of the cover body 51 are also within the scope of the disclosure. The one or more attachment features 100 may be located at an underside 76 of the cover body 51, such as at the surface facing toward the boat 10 for example. An attachment feature 100 as described herein is intended to restrict separation of the cover body 51 from the boat 10 at a desired location, such as during installation of the cover 50 about the boat 10. Further, an attachment feature 100 may allow the cover body 51 to move in a required manner as the fastening system 62 is tightened to increase the tension the cover body 51.

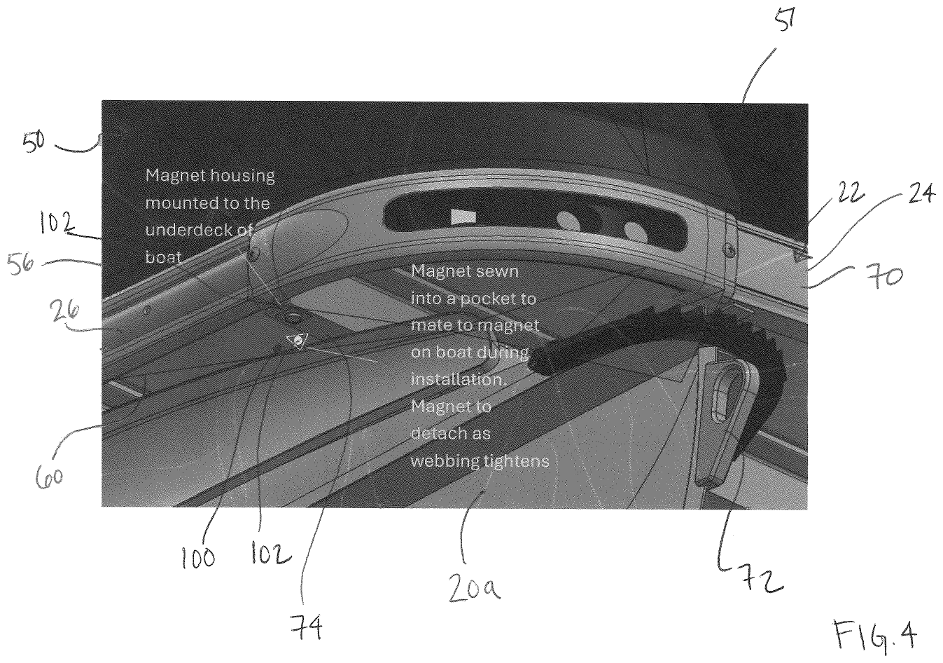

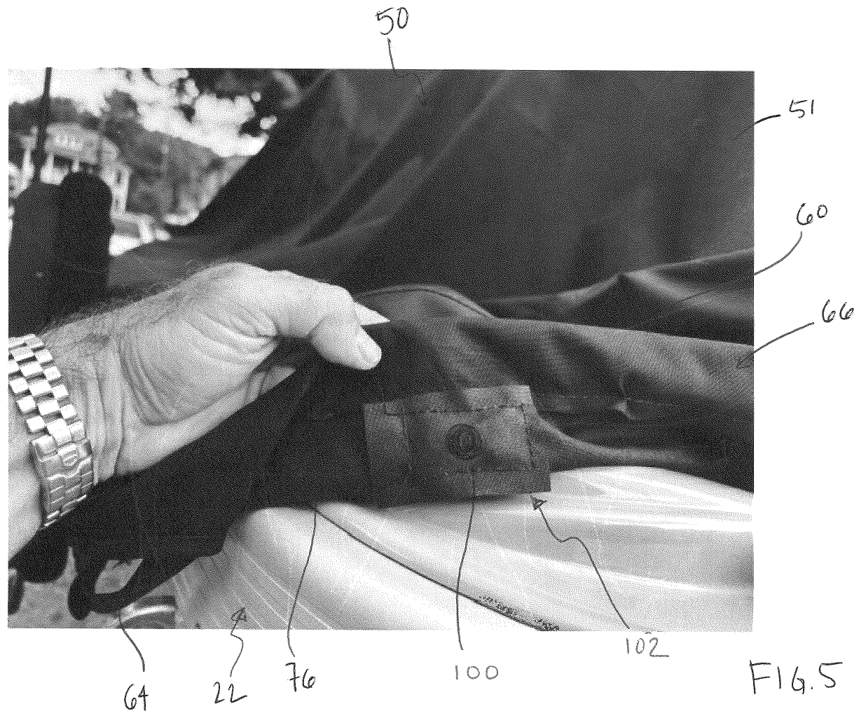

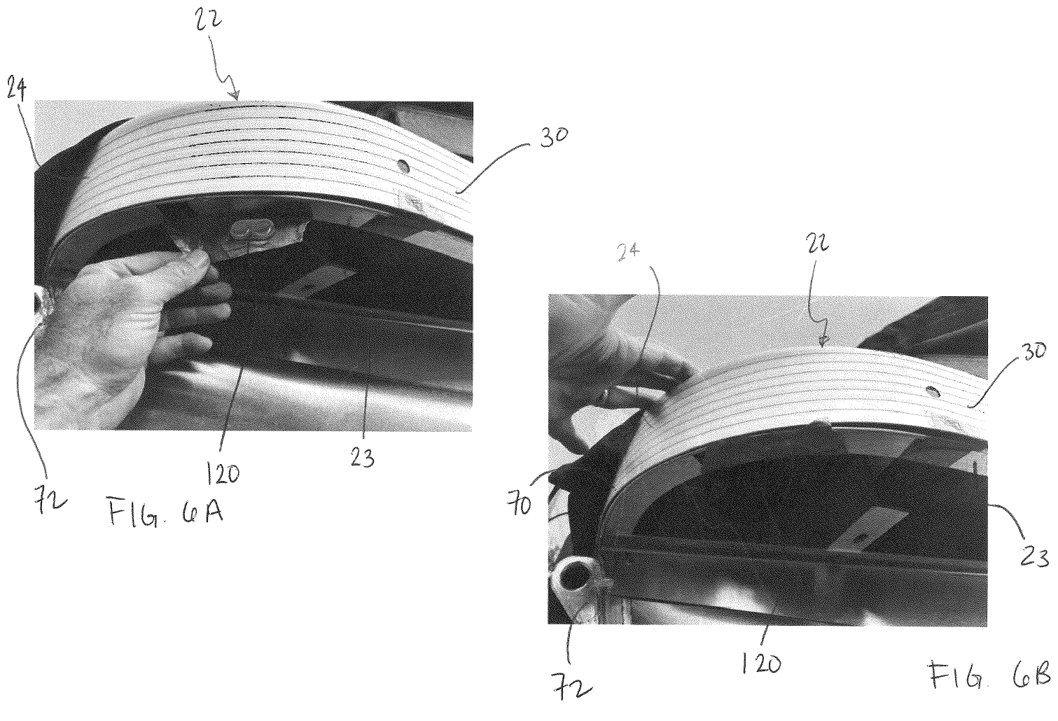

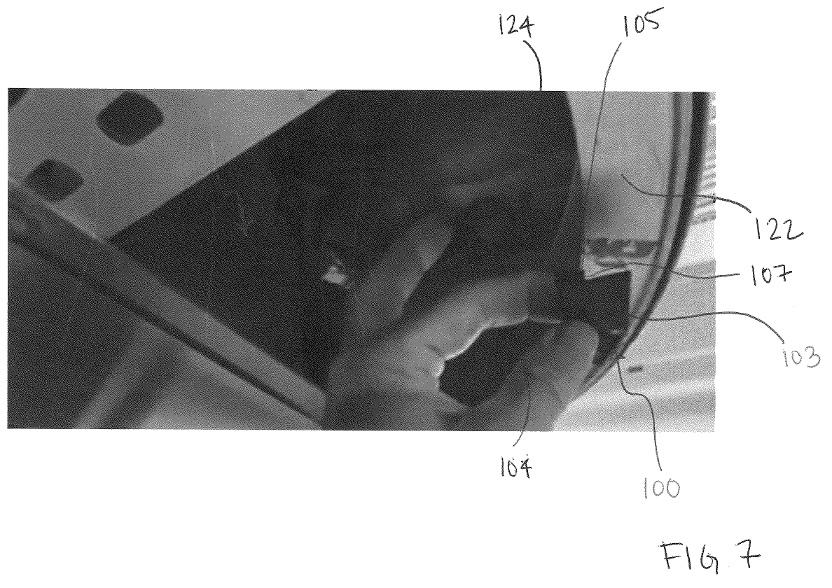

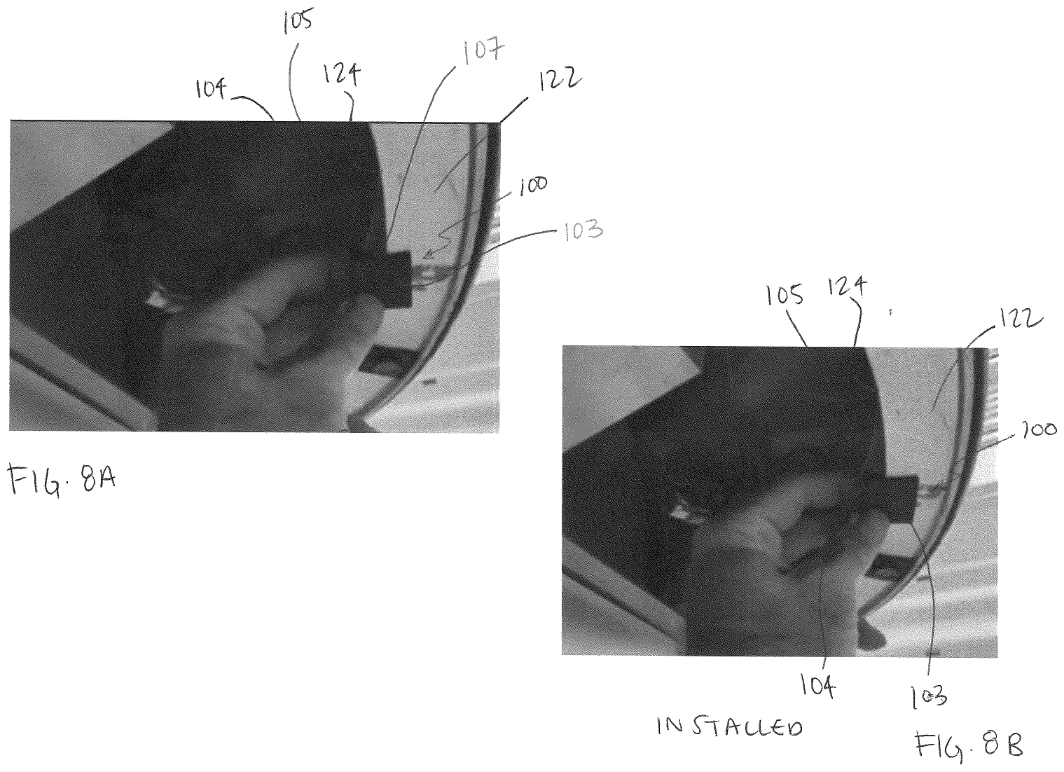

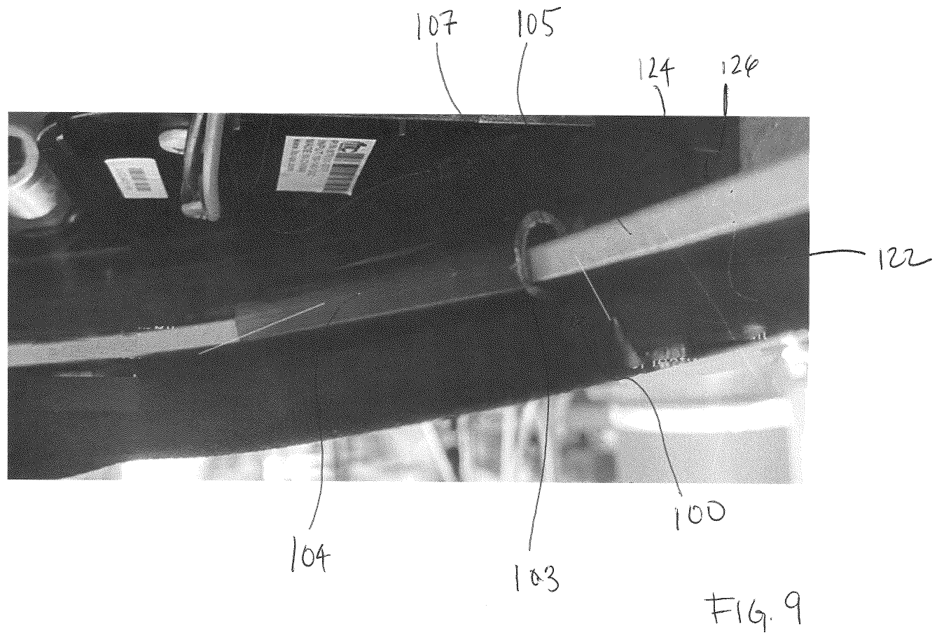

With respect to FIGS. 4-6B, an example of an attachment feature 100 is illustrated. As shown, the attachment feature 100 includes at least one magnet. It should be understood that although a single magnet may be described herein with reference to a respective attachment feature 100, embodiments where a single attachment feature includes a plurality of magnets are also contemplated herein. Further, the configuration of the one or more magnets of the attachment feature 100 may be selected based on a desired magnetic attraction to the boat 10.

The at least one magnet 100 may be attached to the cover body 51 in any suitable manner. For example, the magnets 100 may be chemically bonded to a surface, such as surface 76, of the cover body 51. In other embodiments, the at least one magnet 100 may be mechanically fastened to the cover body 51. In some embodiments, the magnets 100 are embedded within the fabric of the cover body 51. For example, a pocket 102 may be formed at the cover body 51 and the one or more magnets 100 may be enclosed within the pocket 102. By arranging one of more layers of fabric in an overlapping arrangement with the one or more magnets 100, such as at a position between the magnet 100 and a corresponding portion of the boat 10 for example, the force required to separate the magnet 100 from the corresponding portion of the boat may be reduced. Further, because the edges of the magnets 100 will be covered, the potential for damage to the boat 10 resulting from contact with the magnets 100 is reduced.

A receiving feature 120 may be permanently or removably located at the boat 10 at a position generally aligned with a corresponding attachment feature 100 when the cover body 51 is attached to the boat in an untensioned configuration. In the illustrated, non-limiting embodiment, the receiving feature 120 is arranged at an underside 23 of the deck 22 of the boat 10. The receiving feature 120 may include one or more magnets, or alternatively or additionally, may include a magnetic material. For example, a steel plate may be positioned about the boat 10 and the one or more magnets that form a corresponding attachment feature 100 at the cover body 51 may be magnetically attracted to the magnetic material.

During installation of the cover 50 about the boat 10, the at least one attachment feature 100 is generally positioned near a corresponding receiving feature 120 of the boat 10. The magnetic force between the attachment feature 100 and the receiving feature 120 allows the attachment feature 100 of the cover body 51 to self-locate even when the attachment feature 100 is misaligned with the receiving feature 120. With the first and second attachment features 100 of the cover body 51 connected to respective receiving features 120 of the boat 10, movement of the cover body 51 at the attachment features 100 relative to the boat 10 is generally limited. In an embodiment, the attractive force between an attachment feature 100 and a corresponding receiving feature 120 is limited. As tension is applied to the cover body 51 via the fastening system 62, the tension acting on the cover body 51 may pull the attachment feature 100 out of engagement with the corresponding receiving feature 120. Accordingly, in some embodiments, the tension acting on the cover body 51 is sufficient to overcome the attractive force between the attachment feature 100 and the receiving feature 120. Because the magnetic attachment feature 100 is separated from the receiving feature 120 during the process of tensioning the cover body 51, later removal of the cover 50 will not require manual separation of the attachment feature 100 from the receiving feature 120.

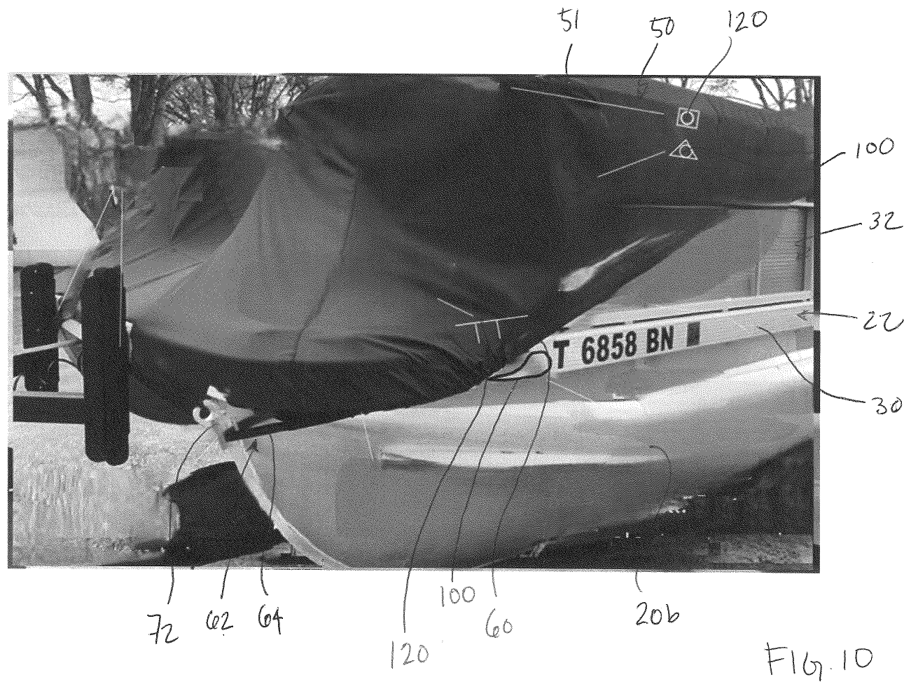

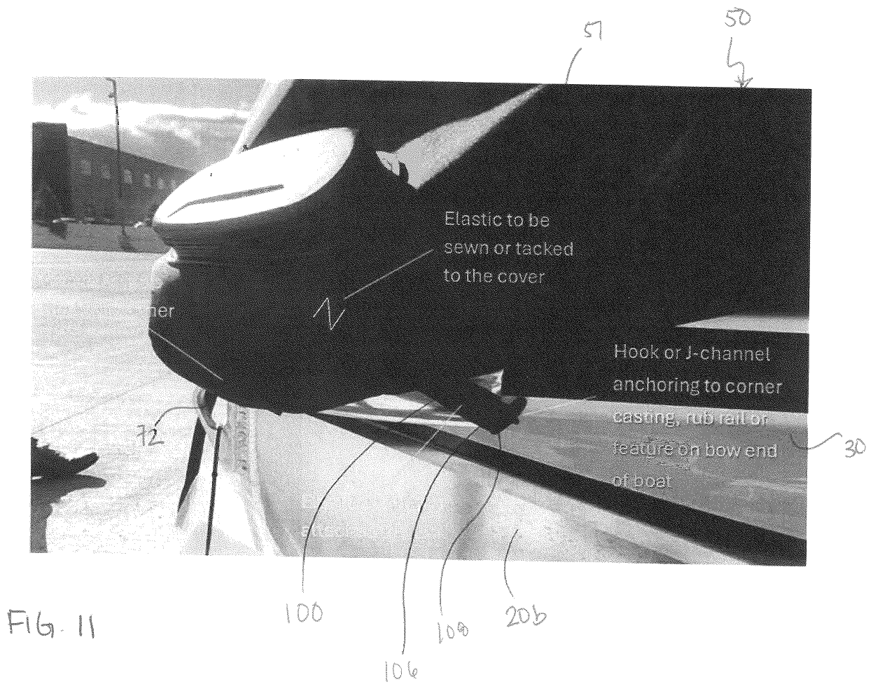

With reference now to FIGS. 7-9, another example of an attachment feature 100 arranged at the cover body 51 is illustrated. As shown, the attachment feature 100 includes a contoured channel or clip, such as a U-shaped or J-shaped clip for example, formed from a semi-rigid plastic. In such embodiments, the contoured clip may have a first arm 103, and a second arm 105, connected by a distal end 104 of the clip 100 such that a clearance 107 is formed between the first and second arms 103, 105. In embodiments where the contoured clip 100 has a J-shape, an axial length of the first arm 103 may be greater than the axial length of the second arm.

The contoured clip 100 may be sewn or chemically attached to the cover body 51, such as at a location near the bottom 60 thereof. In an embodiment, the first arm 103 of the contoured clip is attached to the cover 50 such that the second arm extends therefrom, toward the underside of the boat 10. The rub rail 70 or at least a portion of the deck 22 or hull may include an inwardly extending flange 122. In an embodiment, a distal end 104 of the J-shaped clip 100 is configured to wrap about the end 124 of the inwardly extending flange 122 and engage an upper surface 126 thereof. When installed, the end 124 of the flange 122 is received within the clearance 107 formed between the first and second arms 103, 105 and may abut against the distal end 104 of the contoured clip 100.

During installation of the cover 50, a user positions the bottom 60 of the cover body 51 including the contoured clip 100 at an underside of the boat 10. Specifically, the user may position the second arm 105 of the contoured clip 100 proximate the end 124 of the inwardly extending flange 122 and above the upper surface 126 such that the second arm 105 slidably engages the upper surface 126 of the inwardly extending flange 122. With the first and second attachment features 100 of the cover body 51 connected to respective receiving features 120 of the boat 10, movement of the cover body 51 relative to the boat 10 at the location of the attachment features 100 is generally limited. As tension is applied to the cover body 51 via the fastening system 62, the contoured channel 100 remains engaged with the inwardly extending flange 122. In such embodiments, a user may be required to manually separate the contoured channel 100 from the flange 122 of the rub rail 70 during removal of the cover 50 from the boat 10.

In yet another embodiment, the at least one attachment feature 100 arranged at the cover body 51 includes a tension member. The tension member 100 may but need not be formed from an elastic material such that the tension member is expandable. In an embodiment, the tension member 100 has a looped or continuous configuration. In such embodiments, the receiving feature 120 arranged at the boat 10 may be a fixture of the boat 10. For example, the receiving feature 120 may be a cleat arranged at an upper surface of the deck 22, such as at a lateral side 28, 30 of the deck 22 near the bow 24. When the looped tension member 100 is installed about the fixture 120, movement of the cover body 51 relative to the boat 10 is restricted. However, the overall size of the looped tension member 100 relative to the size of the fixture may be chosen to allow a limited amount of float or movement of the cover body 51 relative to the boat 10 even when the tension member 100 is connected to the fixture 120.

In other embodiments, as shown in FIG. 11, the tension member 100 does not have a continuous configuration. Rather, a first end (not shown) of the tension member 100 may be attached to the cover body 51 and a second, opposite end 106 of the tension member 100, distal from the cover body 51, may include a hook or other engagement member 108. Similar to the contoured channel previously described herein, the engagement member 108 may be configured to wrap about the rub rail 70 and/or engage a corresponding surface 126 thereof. Alternatively, the engagement member 108 may be connectable to another receiving feature arranged about the boat 10, such as a feature like a groove formed at the deck 22 for example.

During installation of the cover body 51, a user positions the front or bow end 52 of the cover body 51 generally over the rub rail 70 at the bow 24 of the boat 10. In an embodiment, the one or more pockets 74 formed at the corners of the bow end 52 of the cover body 51 are seated against the corners of the bow end 24 of the deck 22. The at least one attachment feature 100 of the cover body 51, for example the tension member, is connected to a corresponding receiving feature 120 of the boat 10. As previously described, an engagement member 108 affixed to the tension member 100 may be connected to corresponding receiving feature 120, or alternatively, the tension member 100 may be wrapped about a fixture, such as a cleat 120 arranged at an upper surface of the deck 22. With the at least one attachment feature of the cover body 51 connected to a respective receiving feature 120 of the boat 10, movement of the cover body 51 relative to the boat 10 at the location of the attachment feature 100 is limited. As tension is applied to the cover body 51 via the fastening system 62, the tension member 100 may remain engaged with a corresponding receiving feature 120, thereby requiring manual separation of the attachment feature 100 from the receiving feature 120 by a user during removal of the cover 50 from the boat 10.

A cover 50 for a boat, such as a pontoon boat 10, as illustrated and described herein provides one or more contoured areas that allow water or other matter to drain from the upper surface of the cover body. Although the cover 50 is illustrated and described herein as being suitable for use when the boat 10 is moored, it should be understood that embodiments where the cover is also suitable for use when the boat 10 is being trailered.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope hereof.

What is claimed is:

1. A cover for a watercraft, comprising:
a cover body connectable to the watercraft;
a fastening system coupled to the cover body, the fastening system being operable to selectively apply tension to the cover body; and
at least one attachment feature arranged at an underside of the cover body, wherein the at least one attachment feature is engageable with a receiving feature of the watercraft to restrict movement of the cover relative to the watercraft when the cover is not tensioned.

2. The cover of claim 1, wherein the at least one attachment feature includes a magnet.

3. The cover of claim 1, wherein the receiving feature is a magnetic material.

4. The cover of claim 3, wherein the receiving feature is a steel plate.

5. The cover of claim 1, wherein the receiving feature includes a magnet.

6. The cover of claim 1, wherein the at least one attachment feature includes a contoured channel.

7. The cover of claim 6, wherein the contoured channel is J-shaped.

8. The cover of claim 1, wherein the at least one attachment feature includes a tension member formed into a continuous loop.

9. The cover of claim 1, wherein the receiving feature is a fixture of the watercraft.

10. The cover of claim 1, wherein the at least one attachment feature includes:
a tension member having a first end attached to the cover and a distal end; and
an engagement feature coupled to the distal end of the tension member, the engagement feature being engageable with the receiving feature of the watercraft to restrict the movement of the cover relative to the watercraft when the cover is not tensioned.

11. The cover of claim 1, wherein the watercraft includes a hull and a rub rail arranged at a periphery of the hull, wherein the receiving feature is arranged at the rub rail.

12. The cover of claim 11, wherein the rub rail includes an inwardly extending flange and the receiving feature is arranged at an upper surface of the inwardly extending flange.

13. A cover for a watercraft, comprising:
a cover body connectable to the watercraft;
a fastening system coupled to the cover body, the fastening system being operable to selectively apply tension to the cover body; and
at least one attachment feature arranged at the cover body and connectable to a receiving feature at the watercraft, the at least one attachment feature being movable relative to the watercraft when coupled to the receiving feature.

14. The cover of claim 13, wherein the at least one attachment feature is automatically decoupled from the receiving feature when tension is applied to the cover body via the fastening system.

15. The cover of claim 14, wherein the at least one attachment feature includes a magnet.

16. The cover of claim 14, wherein the receiving feature is a magnetic material.

17. The cover of claim 14, wherein the cover body comprises a pocket wrappable over a corner of a deck of the watercraft.

18. The cover of claim 14, wherein the at least one attachment feature includes a contoured clip engageable with a flange of the watercraft.

19. The cover of claim 18, wherein the contoured clip is a J-shaped clip having a clearance, and the receiving feature of the watercraft is positionable within the clearance.

20. A cover for a watercraft, comprising:
a cover body connectable to the watercraft;
a fastening system coupled to the cover body, the fastening system being operable to selectively apply tension to the cover body;
at least one attachment feature arranged at an underside of the cover body, the at least one attachment feature being engageable with the watercraft; and
wherein the at least one attachment feature includes a tension member attached to the cover, and an engagement feature coupled to the tension member, the engagement feature being engageable with the watercraft to restrict movement of the cover relative to the watercraft when the cover is not tensioned.
